(19) United States
(12) Patent Application Publication
(10) Pub. No.: US 2013/0159072 A1
(43) Pub. Date: Jun. 20, 2013

(54) Family Plan Promotional Offer Sharing

(71) Applicant: Srinivas Vadhri, Cupertino, CA (US)

(72) Inventor: Srinivas Vadhri, Cupertino, CA (US)

(73) Assignee: eBay, Inc., San Jose, CA (US)

(21) Appl. No.: 13/328,180

(22) Filed: Dec. 16, 2011

(51) Int. Cl. G06Q 30/02

(52) U.S. Cl. 705/14.1

(57) ABSTRACT

Promotional offers are shared among members of a group, such as members of a family plan for cellular telephone billing and/or mobile device data billing. The promotional offers can be presented by a merchant at a point-of-sale during checkout. A payment server can have a memory that store account information for a plurality of customers. The account information can include an indication as to which group a customer belongs. A processor can receive an indication of a desire of a customer to purchase an item, access an account of the customer, determine from the account information to which of the groups the customer belongs, and determine identifications of other members of the group. The processor can facilitate communication of an offer to the other members of the group.

### BACKGROUND

1. Technical Field

The present disclosure generally relates to electronic commerce conducted over a network using a mobile device and, more particularly, relates to sharing promotional offers and other incentives among members of a family cellular telephone/data plan.

2. Related Art

Electronic commerce generally refers to the buying and selling of products or services over an electronic network, such as the Internet. The buying and selling can be facilitated using mobile devices such as cellular telephones having mobile web browsers, smart phones, mobile computers, and electronic note pads. The buying and selling of products or services can occur online or at a brick-and-mortar store. When the buying and selling occurs at a brick-and-mortar store or using a POS environment on a mobile device, then a point-of-sale terminal can facilitate the transaction for the merchant and the mobile device can facilitate the transaction for the customer.

Promotional offers or incentives are often made at the point of sale. Such promotion offers can include non-merchant specific coupons, merchant specific coupons, participation in a rewards program, and participation in a loyalty program, for example. Coupons can allow the customer to purchase products or services at a discount, generally during checkout at the point of sale. The participation in a rewards program or a loyalty program can provide benefits for a customer, such as discounts for products and services to be offered at a later time.

Promotional offers may also be made to customers before or after an actual transaction or purchase. For example, merchants or sellers may send targeted offers or other incentives to specific users, who may be repeat or potential new customers. Delivery can be through mail, email, or other means. Such targeted offers are meant for specific customers.

Thus, currently, an offer or incentive delivered to a customer can be used only by the customer or by others only if the customer then communicates the incentive to others. Many times, the customer may decide not to use the offer and/or not communicate the offer to others due to the inconvenience or time. As a result, potential sales may be lost for the merchant.

### SUMMARY

According to one or more embodiments, a consumer, customer, or user has an account with a payment provider, such as PayPal, Inc. When the customer is ready to make a purchase, such as at a point of sale, the customer can be presented with offers that can be redeemed at the time of checkout or at a later time. The offers may also be presented before or after a purchase. These offers can be extended by the merchant or payment provider automatically to others with which the customer is associated.

According to one or more embodiments, methods and systems are provided for sharing promotional offers among members of a group, such as members of a family plan for cellular telephone billing and/or mobile device data billing. The promotional offers can be presented by a merchant at a point-of-sale during checkout or stored by the merchant or payment provider in the cloud. A payment provider server can have a memory that stores account information for a plurality of customers. The account information can including an indication as to which, if any, group a customer belongs. A processor can receive an indication of a desire of a customer to purchase an item, access an account of the customer, determine from the account information to which, if any, of the groups the customer belongs, and determine identifications of other members of the group. The processor can facilitate communication of an offer to the other members of the group.

According to one or more embodiments, facilitating communication of an offer to members of the group can comprise communicating the identifications of the other members of the group to a mobile device of the customer. Communicating the identifications of the other members of the group to the mobile device of the customer can more readily facilitate selection of which members of the group are to receive the offer. For example, the customer can select which members of the group are to receive the offer and the mobile device can then send the offer to only the selected members of the group. The customer can decide to provide offers to anyone in a group (or receive offers from others in a group) either through a mobile device, through the Internet or via any virtual environment, e.g., the cloud. The customer can also change or modify this assignment dynamically.

According to one or more embodiments, facilitating communication of an offer to members of the group can comprise communicating the offer to the other members of the group. That is, the payment server can communicate the offer to the other members of the group. In this manner, the mobile device can be freed from this task and can thus conclude the checkout and/or perform other functions more readily. Also, when an offer is delivered to the customer, the offer can be delivered automatically by the merchant or the payment provider to some or all members of a customer group.

### BRIEF DESCRIPTION OF THE DRAWINGS

FIG. 1 is a block diagram showing a family plan promotional offer sharing system, in accordance with one or more embodiments;

FIG. 2 is a front view of a mobile device having a coupon shown on a display thereof, in accordance with one or more embodiments;

FIG. 3 is a front view of the mobile device having a list of group members shown on a display thereof, in accordance with one or more embodiments;

FIG. 4 is a flow chart showing operation of the family plan promotional offer sharing system, in accordance with one or more embodiments; and

FIG. 5 is a flow chart showing operation of the family plan promotional offer sharing system, in accordance with one or more embodiments.

### DETAILED DESCRIPTION

According to one or more embodiments of the present invention, methods and systems are provided for sharing promotional offers among members of a group or family plan, such as a family plan for cellular telephone billing and/or mobile device data billing. Such family plans can be popular because they provide rollover minutes, cost savings, and billing to a single account holder. Each member of the group can have an account with a payment provider, such as PayPal. All members of the group can have accounts with the same payment provider or at least some members of the group can have accounts with different payment providers.

Promotional offers presented by a merchant at a point-of-sale during checkout or at another time can be shared with all members of the group. Promotional offers presented by a merchant at a point-of-sale during checkout or other times can be automatically shared with selected members of the group. The selection of the members of the group to receive the offer can be done by the customer. Members of the group can decide not to receive offers.

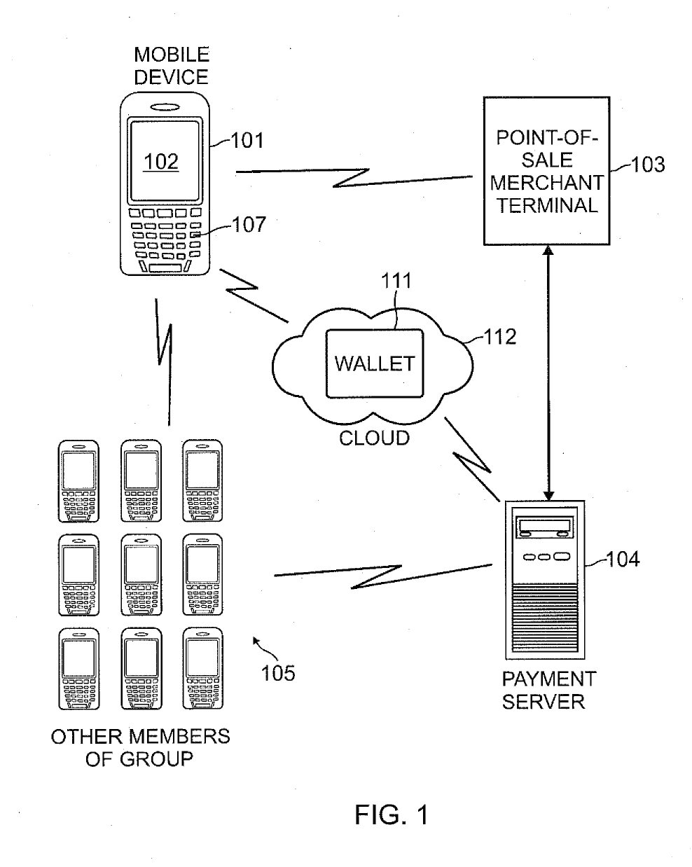

FIG. 1 is a block diagram showing the family plan promotional offer sharing system, in accordance with one or more embodiments. A customer can use a mobile device 101 to facilitate checkout at a point of sale. The checkout can be for completing a purchase of products or services. For example, the checkout can be for facilitating payment for the products or services being purchased.

The mobile device 101 can be a cellular telephone having a mobile web browser, a smart phone, a mobile computer, or an electronic note pad. The mobile device 101 can be any mobile device that is capable of facilitating checkout. The mobile device 101 can have a display 102 for showing information, such as information related to checkout. The mobile device 101 can have controls 107 for controlling the mobile device 101.

The mobile device 101 can cooperate with a merchant terminal 103 to facilitate checkout. The mobile device 101 can facilitate checkout for the customer. The merchant terminal 103 can facilitate checkout for the merchant. The mobile device 101 and the merchant terminal 103 can communicate with one another wirelessly. For example, the mobile device 101 and the merchant terminal 103 can communicate with one another via WiFi, via Bluetooth, via a cellular telephone network, via NFC, or via any other method (wired or wireless).

The merchant terminal 103 can cooperate with a payment server 104 to facilitate authorization of payment from the customer to the merchant. The payment server 104 can be remotely located with respect to the merchant terminal 103. The merchant terminal 103 can be at the point of sale and the payment server 104 can be anywhere else. The merchant terminal 103 can communicate with the payment server 104 via a wired network, via a wireless network, or via any combination thereof. The merchant terminal 103 can communicate with the payment server 104 via the Internet, for example.

The mobile device 101 can be in wireless communication with a plurality of mobile devices of other members of a group 105. The payment server 104 can be in wireless communication with the plurality of mobile devices of the other members of the group 105. The mobile device 101 and/or the payment server 104 can be in wireless communication with the other members of the group 105 via the Internet or via a cellular telephone network, for example.

The group can be any plurality of people that share a cellular phone/data plan. The people of the group can have an association with one another. For example, the people of the group can belong to the same family, work for the same employer, be members of the same organization, and/or shop at the same store. The group need not share a cellular phone/data plan though. In different embodiments, the group can be a group of friends, workers in an office, people in a soccer organization, or any other type of group affiliation. The group may be determined automatically, such as through a common shared phone plan, or selected by one or more members of the group.

A group can be a subset of the people that share a cellular phone/data plan. For example, a group can be one or more people on a list, wherein all of the people on the list share a cellular phone/data plan. The list can be defined by the customer. In this way, a customer can share an offer with those people on the customer's list. Each customer can have a list. The list can be in the profile page of a wallet, for example.

The group can be a family. A family can be a plurality of people that are related to one another, such as by genetics, marriage, or adoption. A family can be a plurality of people that are related to one another by any criteria.

The mobile device 101 and the payment server 104 can communicate with the cloud 112. For example, the mobile device 101 and the payment server 104 can communicate with a wallet 111 of the customer or the group in the cloud 112.

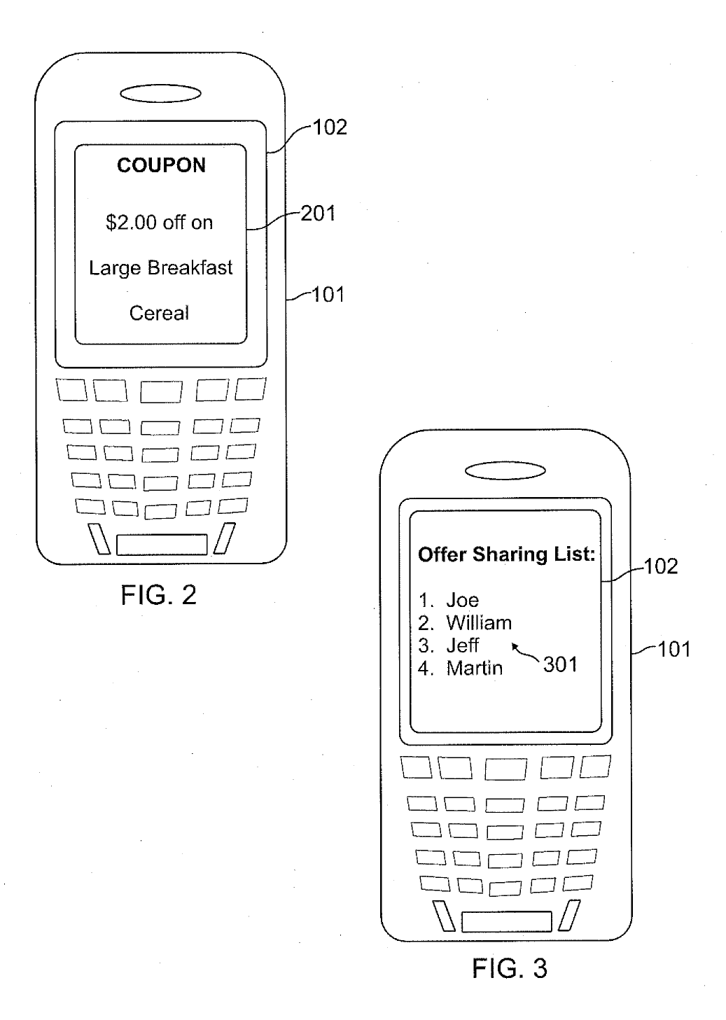

FIG. 2 shows the mobile device 101 having an offer, i.e., a coupon 201, shown on the display 102 thereof, in accordance with one or more embodiments. The offer can be communicated from the merchant terminal 103 to the mobile device 101 at any time. The offer can be communicated from the merchant terminal 103 to the mobile device 101 as the customer approaches the merchant terminal 103 prior to beginning the checkout process, during the checkout process, or after completing the checkout process.

In some instances, the customer can take advantage of the offer during checkout. For example, the offer may provide a discount on a product or service being purchased during checkout. In other instances, the customer can take advantage of the offer after checkout. For example, the customer can take advantage of the offer during a subsequent trip to the same store or to a different store.

As shown in FIG. 1, during checkout the mobile device 101 communicates with the merchant terminal 103. The merchant terminal 103 communicates the offer to the mobile device 101. The offer can be shown upon the display 102 of the mobile device 101. The mobile device 101 can communicate the offer to the mobile devices of other members of the group 105. The offer can be communicated to the mobile devices of the other members of the group 105 either manually or automatically. Manually communicating the offer to the mobile devices of other members of the group 105 can be done by the customer. For example, the customer can use the controls 107 of the mobile device 101 to authorize or cause such communication for each member of the group separately. The customer can predetermine whether offers are to be communicated manually or automatically to the mobile devices of other members of the group 105. For example, this can be done during a setup procedure. When the offer is communicated to the other members of the group 105 automatically, the offer is communicated to all of the other members of the group 105.

The offer can be communicated to the mobile devices of other members of the group 105 by a network, such as the cellular telephone network. The offer can be communicated to the mobile devices of other members of the group 105 using WiFi, BlueTooth, or near field communications (NFC).

After the offer has been communicated to the mobile devices of other members of the group 105, then the other members of the group can take advantage of the offer. In some instances, such as for online sales, the other members of the group can take advantage of the offer immediately or at some other time. For brick-and-mortar store sales, the other members of the group can take advantage of the offer when they visit the store.

FIG. 3 shows the mobile device having a list of group members 301 shown on a display thereof, in accordance with one or more embodiments. The list of group members 301 contains those other group members who are to receive the offer. These can be the other members of the group 105 shown in FIG. 1. The list of group members 301 can be defined by the customer. For example, the list of group members 301 can be defined by the customer during a setup procedure. The list of group members 301 or their telephone numbers can be in the wallet 111 of the customers in the cloud 112. The list of group members 301 or their telephone numbers can be defined in the profile page of the wallet 111, for example.

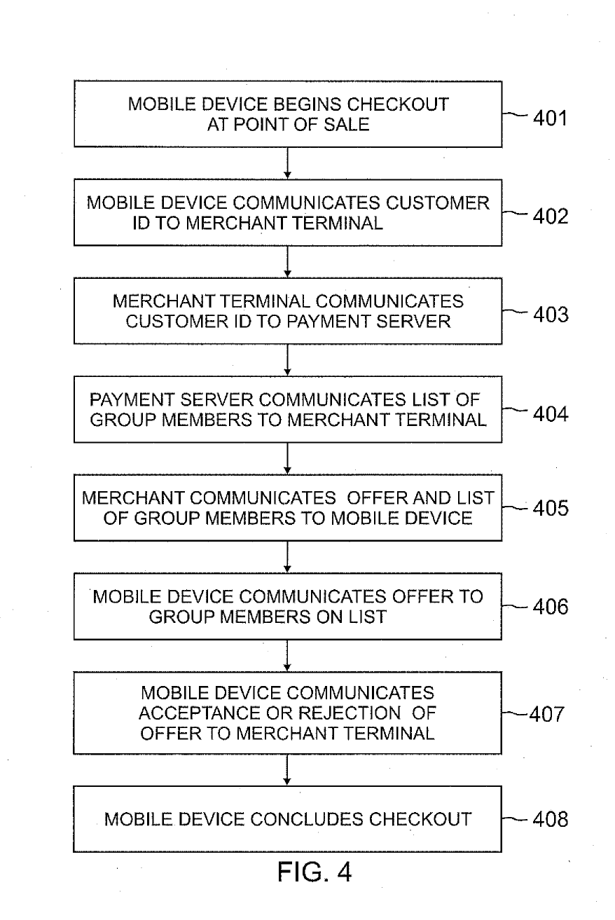

FIG. 4 is a flow chart showing operation of the family plan promotional offer sharing system, in accordance with one or more embodiments. The mobile device 101 begins checkout, at step 401. The point of sale can be at the merchant terminal 103 or can be elsewhere, as discussed herein. Checkout typically involves determining what goods or services are being purchased, identifying the purchaser, and authorizing payment for the purchase. In accordance with one or more embodiments, checkout can additionally include the receipt of an offer from the merchant (or from another merchant) to the customer and the distribution of the offer to those people on the list of group members 301.

The mobile device 101 communicates the customer's identification information (customer ID) to the merchant terminal 103, at step 402. The merchant terminal 103 then communicates the customer ID to the payment server 104, at step 403. The payment server 104 can authorize the transaction if the transaction appears to be legitimate. A PIN or other information may be required from the customer to facilitate authorization.

The payment server 104 can transmit a list of group members 301 to the merchant terminal 103, at step 404. The list of group members 301 can be maintained by the payment server 104, the mobile device 101, in the cloud 112 (such as in a wallet 111), or anywhere else. Regardless of where the list of group members 301 is kept, the list of group members 301 can be communicated to the mobile device 101.

The merchant terminal 405 can communicate an offer (or a plurality of offers) and the list of group members 301 to the mobile device 101, at step 405. The offer can be a coupon, for example, as shown in FIG. 2. The list of group members 301 can be displayed, as shown in FIG. 3. The customer can modify the list of group members 301. Modification to the list of group members 301 can be temporary (can apply to this offer only) or can be permanent (can apply to this offer and all subsequent offers until the list of group members 301 is again modified).

The mobile device 101 can communicate the offer to the people on the list of group members, at step 406. The list of group members 301 can be modified by the customer at any time. If the list of group members 301 has been modified, then the offer will be communicated to those people on the modified list of group members 301. Modifying the list of group members 301 allows the customer to determine which of the group members should get the offer.

The customer can use the mobile device 101 to communicate an acceptance or a rejection of the offer to the merchant terminal 103, at step 407. The offer can apply to an item being purchased during checkout or to any other item. The mobile device can then conclude the checkout, at step 408.

As described with respect to FIG. 4 above, the mobile device 101 can communicate the offer to the other members of the group 105. Alternatively, the payment server 104 can communicate the offer to the other members of the group 105, as discussed below.

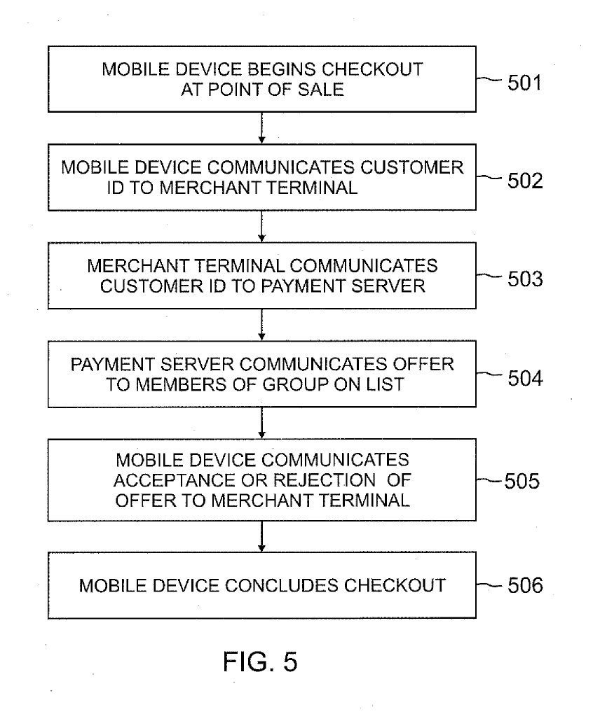

FIG. 5 is a flow chart showing operation of the family plan promotional offer sharing system, in accordance with one or more embodiments. As shown in FIG. 5, the payment server 104 can communicate the offer to the other members of the group 105. The mobile device 101 begins checkout, at step 501. The point of sale can be at the merchant terminal 103 or can be elsewhere, as discussed herein. Checkout typically involves determining what goods or services are being purchased, identifying the purchaser, and authorizing payment for the purchase. In accordance with one or more embodiments, checkout can additional include the receipt of an offer from the merchant (or from another merchant) to the customer and the distribution of the offer to those people on the list of group members 301.

The mobile device 101 communicates the customer's identification information (customer ID) to the merchant terminal 103, at step 502. The merchant terminal 103 then communicates the customer ID to the payment server 104, at step 503. The payment server 104 can authorize the transaction if the transaction appears to be legitimate. A pin number or other information may be required from the customer to facilitate authorization.

The payment server 104 can communicate the offer to the members of the group on the list 301, at step 504. This may offer some advantage with respect to having the customer's mobile device 101 communicate the offer to members of the group on the list 301. For example, it may be quicker to have the payment server 104 communicate the offer to the members of the group on the list 301. It may also speed up checkout by not encumbering the customer's mobile device 101 with this task.

The list of members of the group on the list 301 can be sent to the mobile device 101 and can be modified by the customer even when the offer is communicated by the payment server 103. For example, the list 301 can be communicated from the payment server 104 to the mobile device 101, can be approved and/or modified by the customer, and then can be sent from the mobile device 101 to the payment server 104 prior to the payment server communicating the offer to the members of the group on the list 301. Communication between the mobile device 101 and the payment server can be via the merchant server 103, via the cellular telephone network, via the Internet, or via any other means.

The customer can use the mobile device to communicate an acceptance or a rejection of the offer to the merchant terminal 103, at step 505. The mobile device can then conclude the checkout, at step 506.

The point of purchase can be a brick-and-mortar store. In this instance, the point of purchase can be at the merchant terminal 103. The purchase can be from an Internet store. In this instance, the point of purchase can be the mobile device 101.

An offer can be any coupon, reward, discount or promotion. For example, an offer can allow a customer or other member of a group to purchase goods or services for less than the listed price.

The account holder for the cellular phone/data plan can be defined as a person who is named as the account holder on the plan, a person who receives bills for the plan, a person who pay for the plan, and/or a person who manages use of the plan. The account holder for the plan can be a user of the plan and/or a customer or can not be a user of the plan and/or a customer.

Thus, an offer for a particular user can be automatically transmitted or communicated to one or more members of a group that includes the user. The offer may be given at the time of a purchase or anytime before or after. When an offer is sent to the user, others in the user group may be automatically sent the offer as well, either from the merchant or payment provider.

According to one or more embodiments, a system can comprise a memory for storing account information for a plurality of customers. The memory can be a memory of the payment server 104, for example. The account information can include an indication as to which group, if any, a customer belongs. Each of the groups can contain a plurality of customers.

According to one or more embodiments, a processor can be operable to receive an indication of a desire of a customer to purchase an item, access an account of the customer, determine from the account information to which of the groups the customer belongs, and determine identifications of other members of the group. The processor can be a processor of the payment server 104, for example. The processor can facilitate communication of an offer to the other members of the group.

Facilitating communication of an offer to members of the group can comprise communicating the identifications of other members of the group to a mobile device of the customer. In this manner, the mobile device can then communicate the offer to the members of the group. The customer can select which of the members of the group are to receive the offer.

Facilitating communication of an offer to members of the group can comprise communicating the offer to the other members of the group. Thus, the payment server or an associated device can communicate the offer to the members of the group. The customer can select which members of the group are to receive the offer. The customer can pre-select which members for the group are to receive the offer.

All members of the group can share a cellular phone/data plan. For example, the group is a family and the cellular phone/data plan can be a family plan. The customer can be the account holder for the cellular phone/data plan. Alternatively, the customer can not be the account holder for the cellular phone/data plan. The account holder can be the person who contracted with the cellular/data provider and/or the person who pays for the cellular phone/data plan.

The promotional offer can made to the customer, to members of the group other than the customer, to all members of the group, or to selected members of the group. The group provides a defined set of people having known identifications, cellular telephone numbers, and other information.

The promotional offer can be redeemed during the point-of-sale checkout. The promotional offer can be redeemed at any other time.

The group can have a wallet in the cloud and the point-of-sale checkout can be performed via the wallet. The customer can extend the promotional offer to a list of people who are members of the group, wherein the list is in a wallet of the customer in the cloud. The group can have a P-Card and the point-of-sale checkout can be performed via the P-Card.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Logic may be encoded in a computer readable and executable medium, which may refer to any medium that participates in providing instructions to the processor for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component, volatile media includes dynamic memory, such as system memory component, and transmission media includes coaxial cables, copper wire, and fiber optics, including wires that comprise bus. In one example, transmission media may take the form of acoustic or light waves, such as those generated during radio wave and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
a memory storing account information for a plurality of users, the account information including an indication as to which group of a plurality of groups a user belongs, wherein each of the groups contain a plurality of users;
a processor operable to:
receive an indication of an offer provided or to be provided to a user;
access an account of the user;
determine from the account information to which of the groups the user belongs;
determine identifications of other members of the group; and
facilitate communication of the offer to at least one of the other members of the group.

2. The system as recited in claim 1, wherein facilitating communication of the offer to other members of the group comprises communicating the identifications of the other members of the group to a mobile device of the user.

3. The system as recited in claim 1, wherein facilitating communication of the offer to at least one of the other members of the group comprises automatically communicating the offer to the at least one of the other members of the group.

4. The system as recited in claim 1, wherein all members of the group share a cellular phone/data plan.

5. The system as recited in claim 1, wherein the group is a family.

6. The system as recited in claim 1, wherein the communication of the offer is facilitated to a predetermined subset of the other members of the group.

7. The system as recited in claim 1, wherein a list of members of the group to whom the offer is to be communicated is stored in a cloud.

8. A method for providing an offer to members of a group, comprising:
storing account information for a plurality of users in a memory, the account information including an indication as to which group of a plurality of groups a user belongs, wherein each of the groups contain a plurality of users;
receiving, electronically by a processor of a payment system, an indication of an offer provided or to be provided to a user;
accessing, by the processor, an account of the user;
determining, by the processor, from the account information to which of the groups the user belongs;
determining, by the processor, identifications of other members of the group; and
facilitating communication of the offer to at least one of the other members of the group.

9. The method as recited in claim 8, wherein facilitating communication of an offer to at least one of the other members of the group comprises communicating the identifications of the at least one of the other members of the group to a mobile device of the customer.

10. The method as recited in claim 8, wherein facilitating communication of the offer to at least one of the other members of the group comprises automatically communicating the offer to the at least one of the other members of the group.

11. The method as recited in claim 8, wherein all members of the group share a cellular phone/data plan.

12. The method as recited in claim 8, wherein the group is a family.

13. The method as recited in claim 8, wherein the communication of the offer is facilitated to a predetermined subset of the other members of the group.

14. The method as recited in claim 8, wherein a list of members of the group to whom the offer is to be communicated is stored in a cloud.

15. A non-transitory machine-readable medium comprising a plurality of machine-readable instructions which when executed by one or more processors of a server are adapted to cause the server to perform a method comprising:
storing account information for a plurality of users in a memory, the account information including an indication as to which group of a plurality of groups a user belongs, wherein each of the groups contain a plurality of users;
receiving an indication of an offer provided or to be provided to a user;
accessing an account of the user;
determining from the account information to which of the groups the user belongs;
determining identifications of other members of the group; and
facilitating communication of the offer to at least one of the other members of the group.

16. The non-transitory machine-readable medium as recited in claim 15, wherein facilitating communication of the offer to the at least one of the other members of the group comprises communicating the identifications of the other members of the group to a mobile device of the user.

17. The non-transitory machine-readable medium as recited in claim 15, wherein facilitating communication of the offer to the at least one of the other members of the group comprises automatically communicating the offer to the other members of the group.

18. The non-transitory machine-readable medium as recited in claim 15, wherein all members of the group share a cellular phone/data plan.

19. The non-transitory machine-readable medium as recited in claim 15, wherein the group is a family.

20. The non-transitory machine-readable medium as recited in claim 15, wherein the communication of the offer is facilitated to a predetermined subset of the other members of the group.

21. The non-transitory machine-readable medium as recited in claim 15, wherein a list of members of the group to whom the offer is to be communicated is stored in a cloud.
